(19) United States
(12) Patent Application Publication
(10) Pub. No.: US 2011/0161533 A1
(43) Pub. Date: Jun. 30, 2011

(54) Broadcast by KVM System and Method Thereof

(75) Inventor: Sheng-Peng Lin, Shijr City (TW)

(73) Assignee: ATEN INTERNATIONAL CO., LTD., Shijr City (TW)

(21) Appl. No.: 12/650,678

(22) Filed: Dec. 31, 2009

(51) Int. Cl. G06F 13/12

(52) U.S. Cl. 710/72

(57) ABSTRACT

A system and method for override broadcast in a KVM (Keyboard, video monitor, mouse) system is provided. The KVM system includes a plurality of computers, a plurality of console devices and a KVM switch that connects those computers and console devices with or without network. With a firmware build in the KVM device, the administer of the KVM system can select one of the computers as the broadcaster computer and several of the console devices as the broadcastee console devices through the broadcaster console device. After receiving the broadcast command, the KVM disconnects the signal connections between the broadcastee console devices and the computers that the broadcastee console devices originally connected. The KVM then broadcasts the output signals of the broadcaster computer to the broadcastee console devices.

An override broadcast method in a KVM (Keyboard-Video-Mouse) system, which selectively broadcasts a single broadcaster computer output signals to a plurality of broadcastee console devices or, in particular, to a plurality of distant broadcastee console devices via network.

### BACKGROUND OF THE INVENTION

(1) Field of the Invention

The invention relates to a network override broadcast method in a KVM (Keyboard-Video-Mouse) system which broadcasts the output signal of a broadcaster computer to a plurality of broadcastee console devices via a network or directly.

(2) Description of the Prior Art

A Keyboard-Video-Mouse (KVM) switch allows a user to manipulate a plurality of computes via a single set of console device, including a keyboard, a display and a mouse. Further, in a matrix KVM system, a KVM switch couples a plurality of consoles devices to a plurality of computer. Referring now to FIGS. 1A and 1L, a traditional KVM switch 2 couples a plurality of computers 11 to a plurality of console devices. For example, the plurality of console devices includes a first console device 15, a second console device 16 and a third console device 17. The first console device 15 includes a displays 15a, a mouse 15b and a keyboard 15c. The second console device 16 includes a displays 16a, a mouse 16b and a keyboard 16c. The third console device 17 includes a displays 17a, a mouse 17b and a keyboard 17c. The KVM switch 2 includes a control interface 23 and a computer interface 24. The control interface 23 connects the console devices 15,16 and 17. With the pathway established by the router 22, users can use any one of the console devices to control any selected one of the computers 11. For example, User1 can select and control the first computer 11A by using the first console device 15 via the KVM switch 2; User2 can select and control the second computer 11B by using the second console device 16 via the KVM switch 2; User3 can select and control the third computer 11C by using the third console device 17 via the KVM switch 2.

With the development and progress of the KVM switches, the amount of the console devices and computers that connect to KVM is increasing. The communication between a plurality of uses for coordinate with each other in a KVM system is definitely required.

### SUMMARY OF THE INVENTION

A override broadcast method in a KVM (Keyboard, video monitor, mouse) system is provided. The KVM system includes a plurality of computers, a plurality of console devices and a KVM switch that connects those computers and console devices with or without network.

With a firmware build in the KVM device, the administer of the KVM system can select one of the computers as the broadcaster computer and several of the console devices as the broadcastee console devices through the broadcaster console device. After receiving the broadcast command, the KVM disconnects the signal connections between the broadcastee console devices and the computers that the broadcastee console devices originally connected. The KVM then broadcasts the output signals of the broadcaster computer to the broadcastee console devices.

After receiving the broadcast terminate command, the KVM resumes transmitting the signals between the broadcastee console devices and the computers that the broadcastee console devices is originally connected to.

All these objects are achieved by the override method and the KVM system described below.

### BRIEF DESCRIPTION OF THE DRAWINGS

The present invention will now be specified with reference to its preferred embodiment illustrated in the drawings, in which:

FIG. 1A is a pictorial framework of a traditional KVM system;

FIG. 1B is a pictorial framework of a preferred KVM system for fulfilling an override method;

FIG. 1C is a pictorial framework of a preferred KVM system with a network connecting to distant console devices;

FIG. 1D is a pictorial framework of a preferred KVM system for fulfilling an override method with a network connecting to distant console devices;

FIG. 1E is a pop-up window for the selection of broadcast computer and broadcastee console devices;

FIG. 1F is a schematic view of a preferred KVM system;

FIG. 1G is a schematic view of a preferred KVM system for fulfilling an override method;

FIG. 1H is a schematic view of a preferred KVM system with a network connecting to distant console devices;

FIG. 1I is a schematic view of a preferred KVM system for fulfilling an override method with a network connecting to distant console devices;

FIG. 1J is a pictorial framework of a preferred KVM system for fulfilling an override method with a network connecting to all the console devices; and

FIG. 1K is a schematic view of a preferred KVM system for fulfilling an override method with a network connecting to all the console devices;

FIG. 1L is a schematic view of a traditional KVM system;

FIG. 2 is a schematic view of a preferred KVM system;

FIG. 3A is a pictorial view of a control interface;

FIG. 3B is a pictorial view of a computer interface;

### DESCRIPTION OF THE PREFERRED EMBODIMENT

The invention disclosed herein is directed to an override method in a KVM system. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

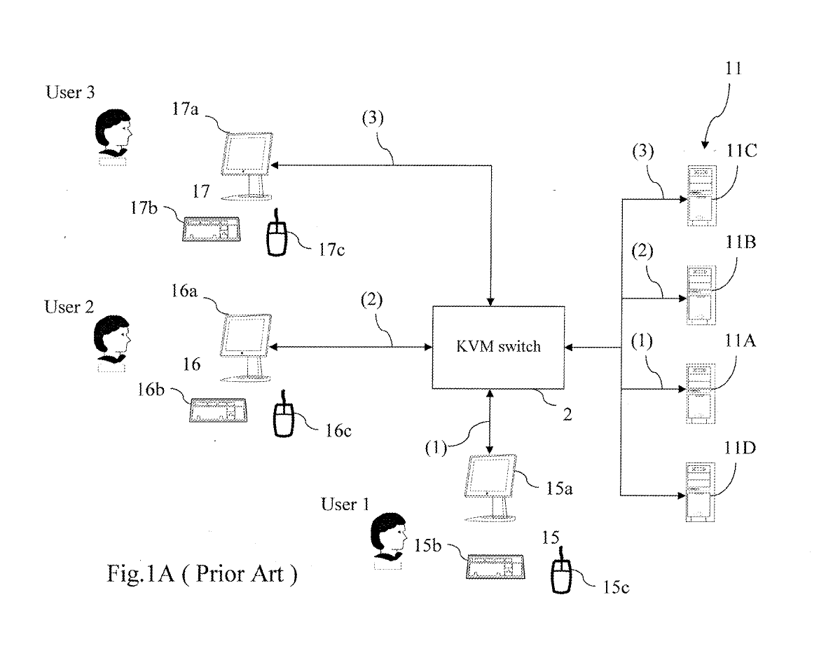

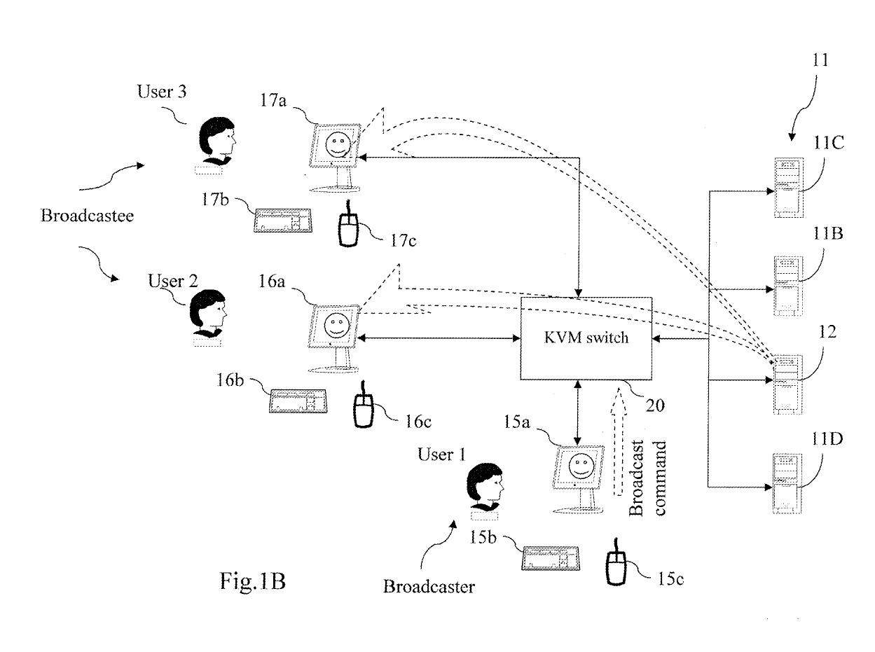

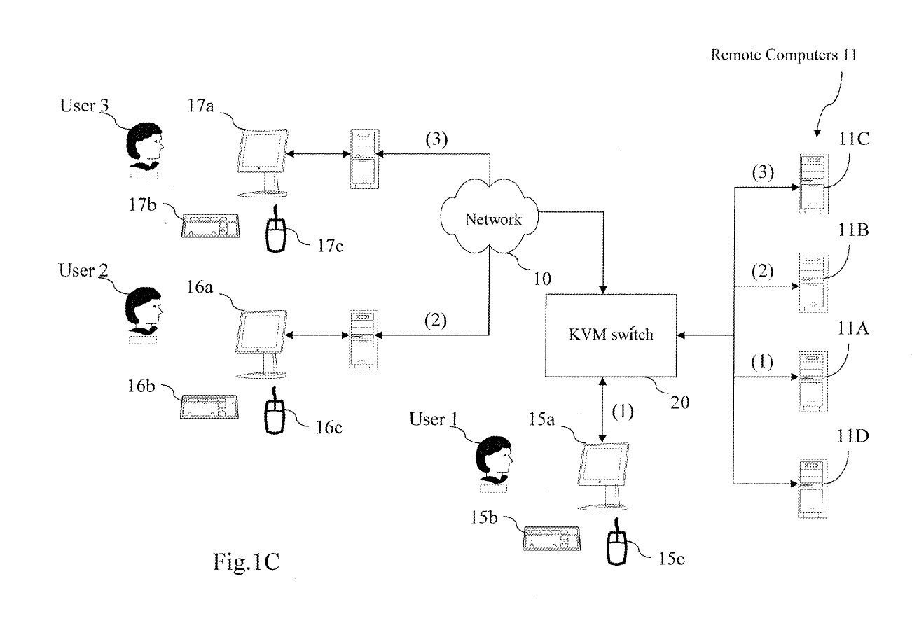

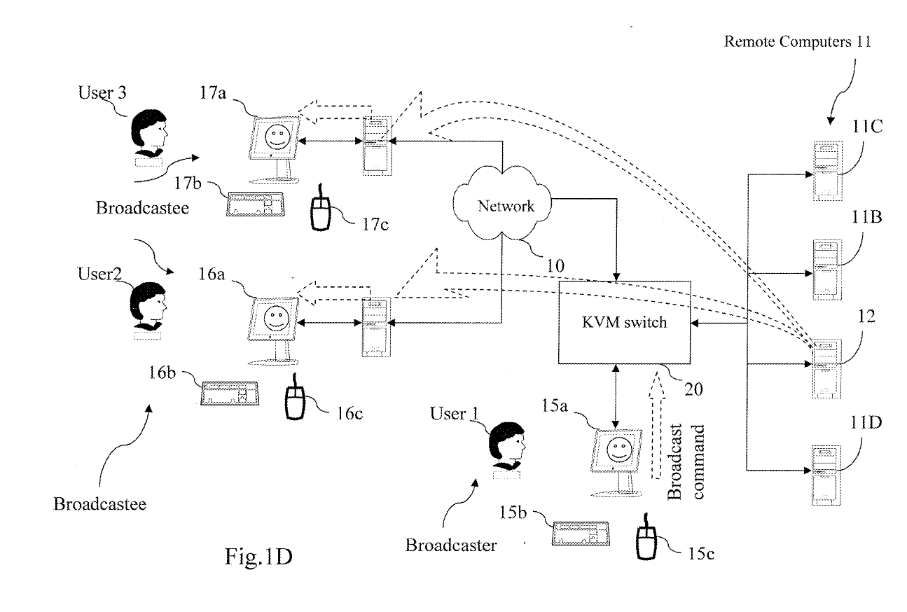

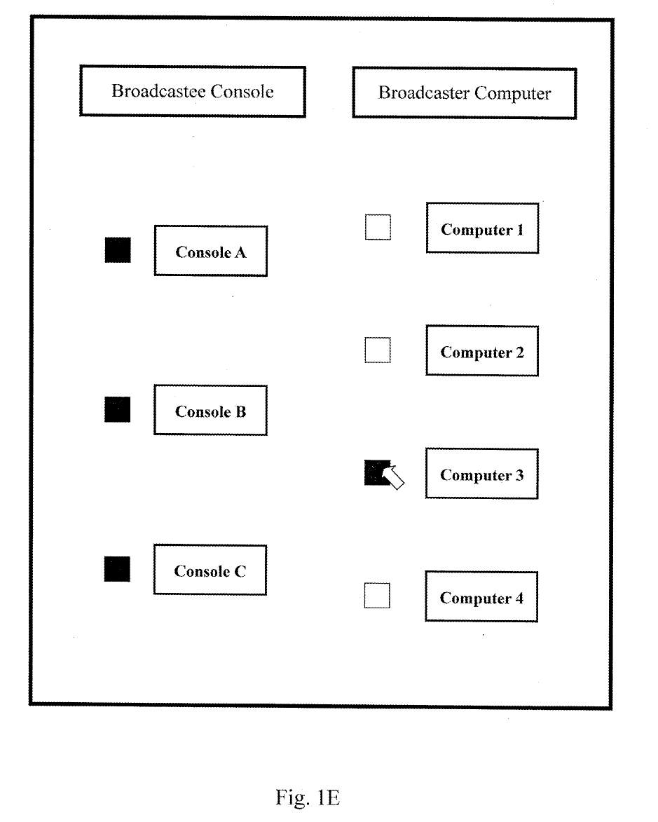

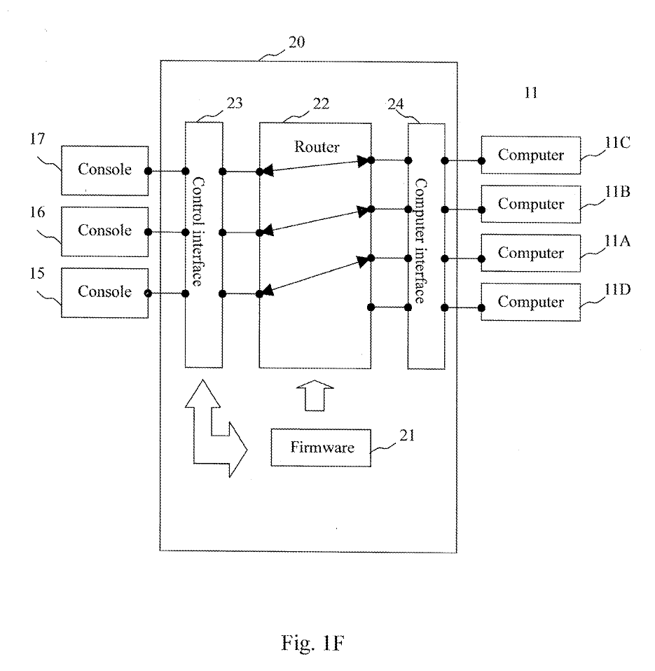

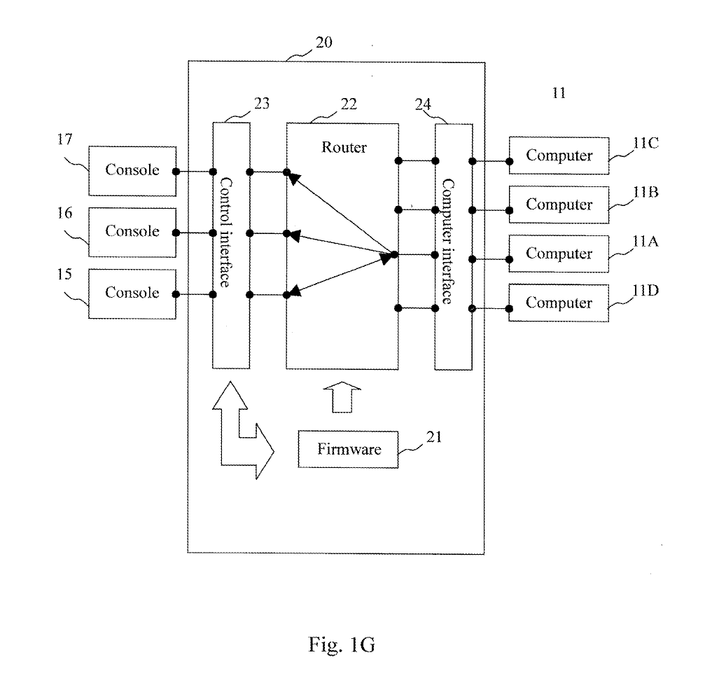

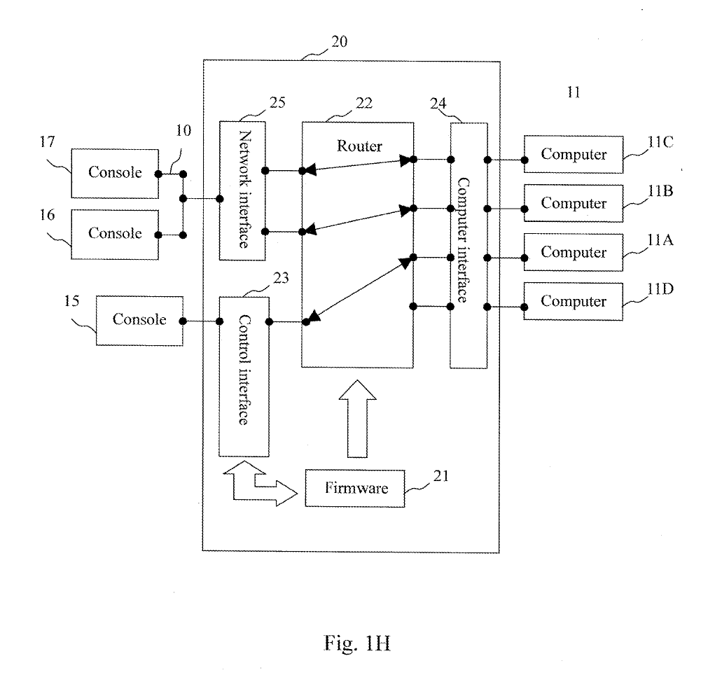

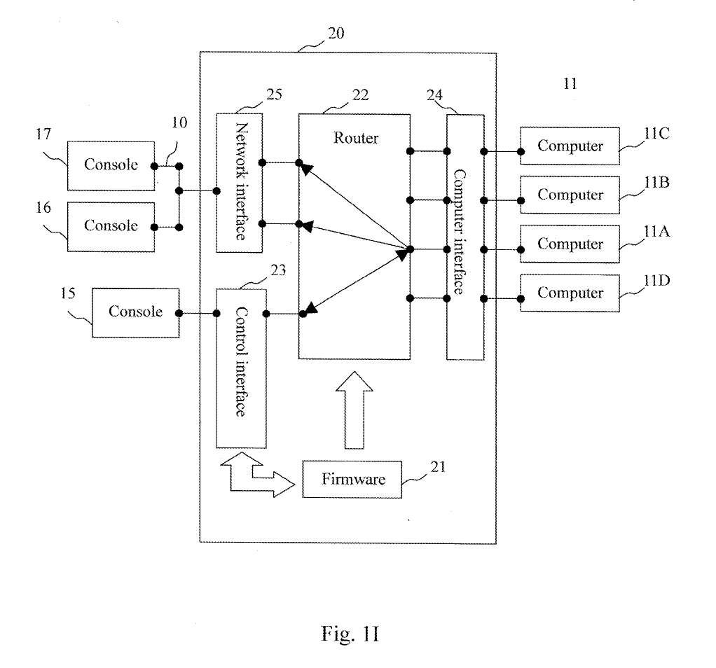

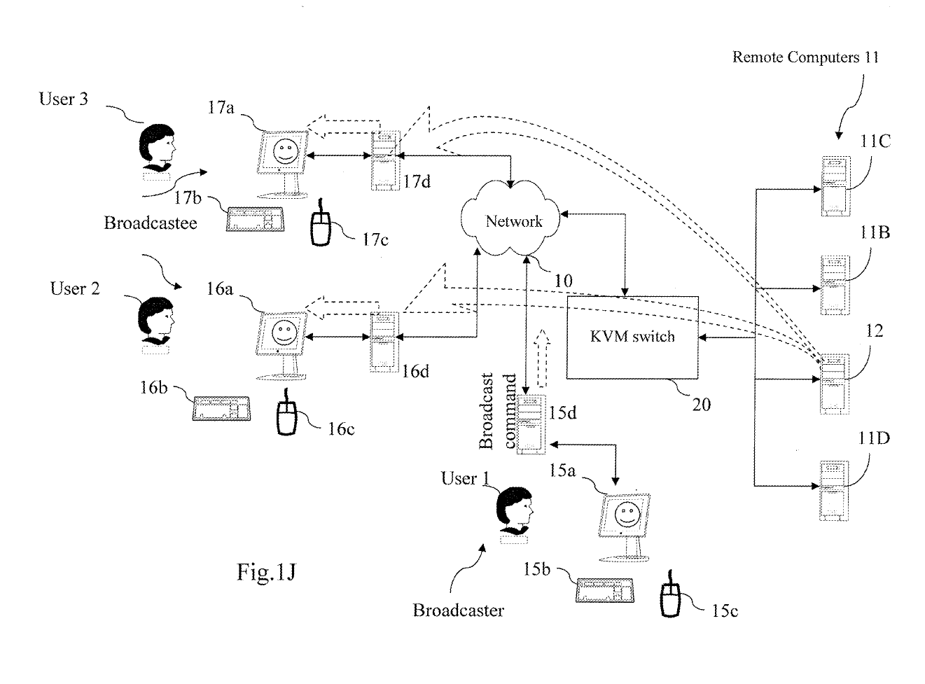

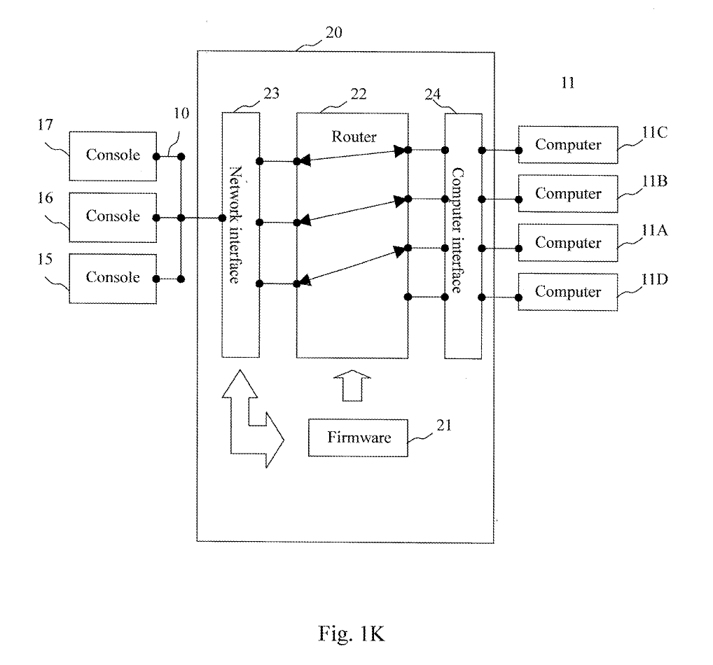

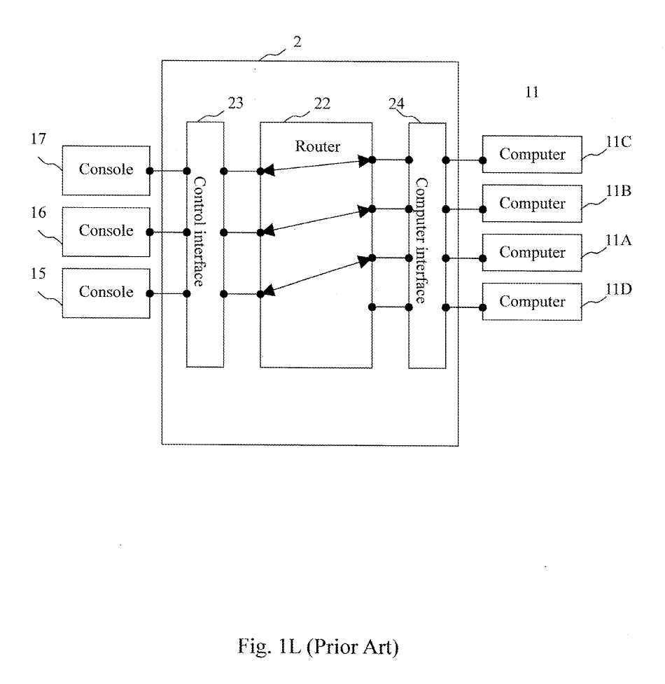

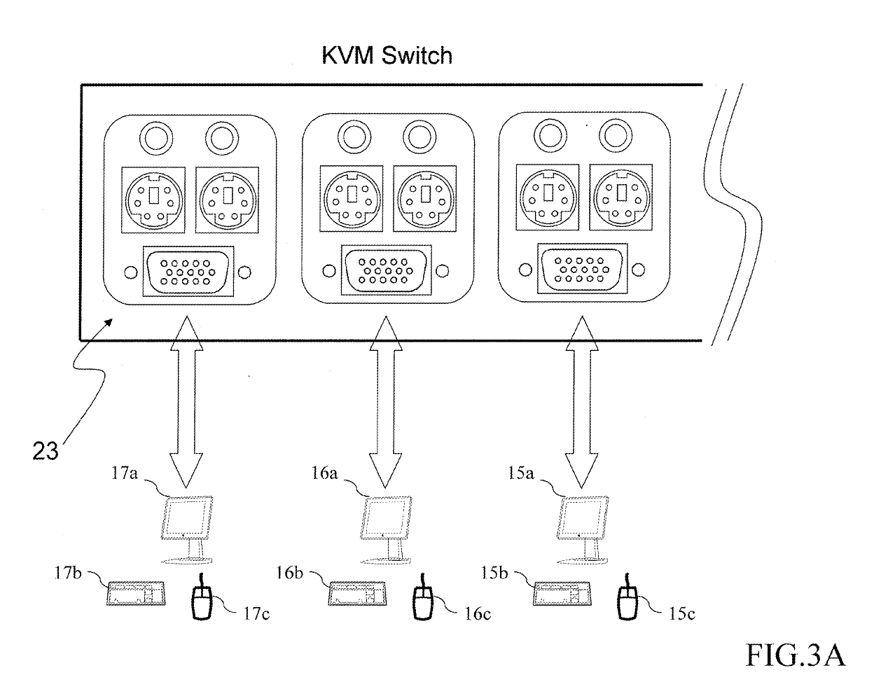

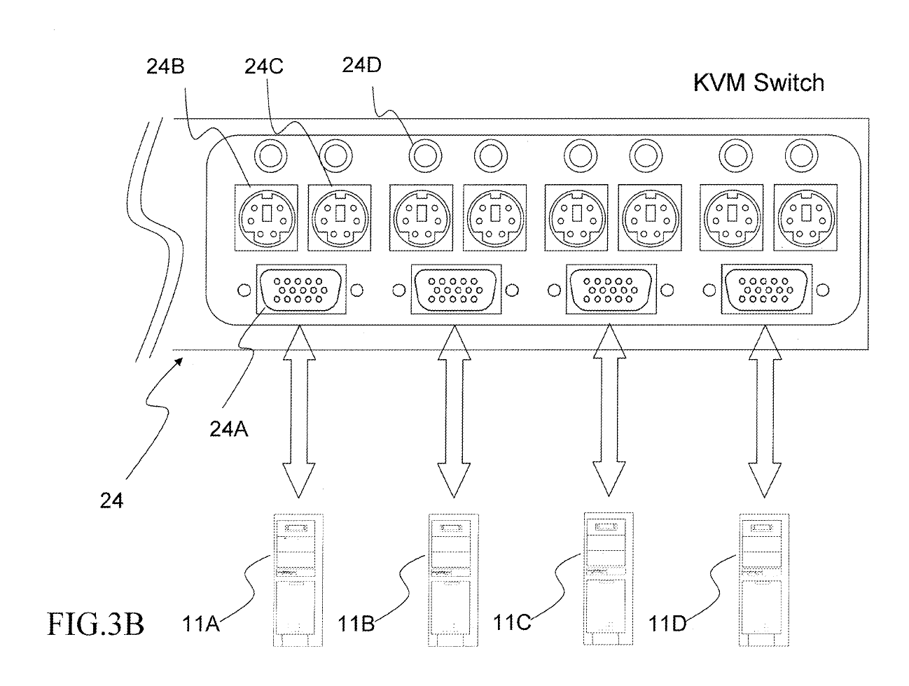

Referring now to FIG. 1B, FIG. 1F, FIG. 3A and FIG. 3B, in the KVM system according to the present invention, a KVM switch 20 couples a plurality of computers 11 to a plurality of console devices. For example, the plurality of console devices includes a first console device 15, a second console device 16 and a third console device 17. The first console device 15 includes a displays 15a, a mouse 15b and a keyboard 15c. The second console device 16 includes a displays 16a, a mouse 16b and a keyboard 16c. The third console device 17 includes a displays 17a, a mouse 15b and a keyboard 17c. The KVM switch 20 includes a control interface 23 and a computer interface 24. The control interface 23 connects the console devices 15,16 and 17, and thus receives control signals form the console devices 15,16 and 17. As shown in FIG. 3B, the computer interface 24 may further include a video port 24A, a keyboard port 24B and a mouse port 24C for connecting one or more than one computers. The computer interface 24 further includes an audio interface 24D for transmitting audio signals to computers 11A, 11B, 11C and 11D and receiving audio signals from the computers 11A, 11B, 11C and 11D. The computer interface 24 connects the computers 11A,11B,11C and 11D, and thus receives video signals form the computers 11A,11B,11C and 11D. With the pathway established by the router 22, users can use any one of the console devices to control any selected one of the computers 11. For example, User1 can select and control the first computer 11A by using the first console device 15 via the KVM switch 20; User2 can select and control the second computer 11B by using the second console device 16 via the KVM switch 20; User3 can select and control the third computer 11C by using the third console device 17 via the KVM switch 20.

Referring now to FIG. 1B, the pictorial diagram of the KVM system according to the present invention, User1 may get the administration of the KVM system after a log-in step and become a broadcaster. During a broadcast session, after sending out a broadcast command to the KVM switch 20 from the first console device 15 by User1, a pop-up window (FIG. 1E) or an OSD (on-screen display) menu shows up on the display of the first console device 15. For example, User1 uses a hot-key command or a dedicated keypad to activate the OSD menu. User1 assigns one computer 11A to be the broadcaster computer and choose a number of console devices other than the first console device 15 to be the broadcastee console devices. These assignment commands then are sent to the KVM switch 20.

Referring next to FIGS. 1B & 1G, the firmware 21 in the KVM switch 20 change the signal routing of the router 22 in response to the assignment commands from the first console device 15. For example, the console devices 15,16,17 operate the computers 11A,11B,11C respectively before broadcasting as shown in FIG. 1A and FIG. 1F. After receiving the broadcast assignment commands from the first console device 15, the firmware 21 disconnects the signals between the console devices 16,17 and the computers 11B,11C, and then broadcast output signals of the computer 11A to the console devices 16,17. The output signals of the computer 11A may include audio, video or USB signal. At this moment, the keyboards 16b,17b and mice 16c,17c are disabled, or disconnected to the any one of the computers 11A, 11B, 11C and 11D by the KVM switch 20. Alternatively, the controls signals form the keyboards 16b,17b and mice 16c,17c are ignored.

To terminate the broadcast session, User1 sends out a broadcast terminate command to the KVM switch 20. The firmware 21 on the KVM switch 20 disconnects the broadcasted output signals from the first computer 11A to the console devices 16,17, and then resume the original connections between the console devices 16,17 and the computers 11B,11C respectively as shown in FIG. 1F. That is, the second console device 16 is re-connected to the second computer 11B, and the third console device 17 is re-connected to the third computer 11B via the KVM switch 20. The KVM switch 20 may include a storage device for storing the connection relationship between the condole devices and the computers.

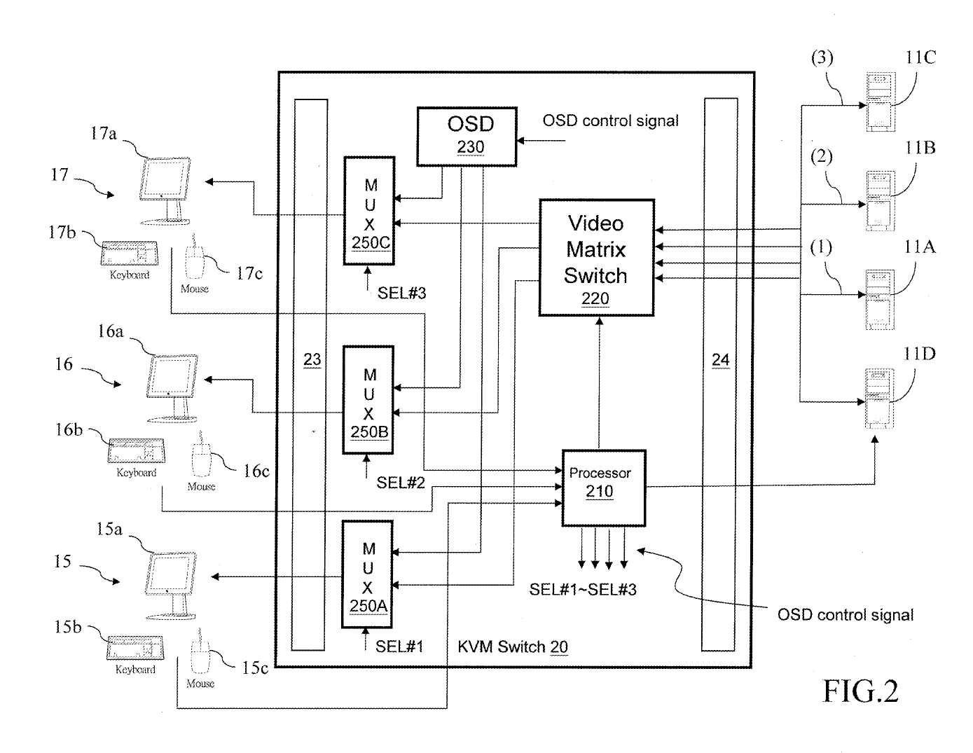

Referring to FIG. 2, in one preferred embodiment, besides the control interface 23 and the computer interface 24, the KVM switch 20 of the present invention shown in FIG. 1A further includes a CPU or a processor 210, a video matrix switch 220, an OSD generating circuit 230, a plurality of multiplexers 250A, 250B and 250C. The firmware 21 shown in FIG. 1F can be executed by the processor 210 to control the video matrix switch 220 to route the video signals between the computers 11A, 11B, 11C and 11D and the multiplexers 250A, 250B and 250C. The multiplexers 250A, 250B and 250C are in communication with the processor 210, the video matrix switch 220 and the OSD generating circuit 230. Each of the multiplexers 250A, 250B and 250C further corresponds to a set of console device. The router 22 shown in FIG. 1F can include the video matrix switch 220. The video matrix switch 220 selectively outputs the video signals form the computers 11A, 11B, 11C and 11D to provide a plurality of selected video signals to the multiplexers 250A, 250B and 250C. In one preferred embodiment, the video matrix switch 220 can be AD8175 supplied by Analog Devices Inc. The processor 210 controls the OSD generating circuit 230 to generate an OSD menu to be displayed on the displays 15a, 15b and 15c by sending an OSD control signal. The OSD menu and the selected video signals from the video matrix switch 220 are inputted into the multiplexers 250A, 250B and 250C. The processor 210 also controls the multiplexers 250A, 250B and 250C by sending control signal SEL#1, SEL#2 and SEL#3 such that the OSD menu may be combined with the selected video signals from any one of the computers 11A, 11B, 11C and 11D, or overlapped with the selected video signals form any one of the computers 11A, 11B, 11C and 11D. Alternatively, the OSD menu may be displayed on the displays 15a, 16a and 17a with blank background. That is, the multiplexers 250A, 250B and 250C block the video signals from the computers 11A, 11B, 11C and 11D, and output the OSD menu to the displays 15a, 16a and 17a only.

On the other hand, keyboard signals form the keyboards 15b, 16b and 17b or mouse signals from mice 15c, 16c and 17c are inputted to the processor 210 of the KVM switch 20 through the control interface 23, then the processor 210 routes the keyboard signals or the mouse signals to the computers 11A, 11B, 11C and 11D, respectively, according to a path setting determined by users. For example, a user in front of console device 17 selects the computer 11A and another user in front of console device 16 selects the computer 11B, then keyboard signals from the keyboard 17b are routed to the computer 11A and keyboard signals from the keyboard 16b are routed to the computer 11B. In one preferred embodiment, during the video signals from the broadcaster computer are being broadcasted, processor 210 blocks keyboard signals or mouse signals from the console devices which are broadcasted during broadcasting. That is, the keyboards and mice of broadcastee console devices are temporarily disabled. Therefore, broadcastee users are forced to focus on the demonstration, represented by video signals from the computer 11A, made by the broadcaster. In one preferred embodiment, an administrator or a user with higher authority, in front of the console device 15, is able to broadcast how to operate of the KVM switch 20 to the other users with lower authority (broadcastee) for demonstration through the OSD menu.

In another preferred embodiment, referring now to FIG. 1C and FIG. 1H, a KVM switch 20 couples a plurality of controlled computers 11 to a first console device 15 located locally, and a plurality of console devices located remotely via a network. For example, the plurality of console devices include a second console device 16 and a third console device 17. The first console device 15 includes a displays 15a, a mouse 15b and a keyboard 15c. The second console device 16 includes a displays 16a, a mouse 16b and a keyboard 16c. The third console device 17 includes a displays 17a, a mouse 15b and a keyboard 17c. The KVM switch 20 includes a control interface 23, a computer interface 24 and a network interface 25. The control interface 23 connects the first console device 15. The computer interface 24 connects the controlled computers 11A,11B,11C and 11D. The network interface 25 connects the console devices 16, 17 associated with computers 16d, 17d through network 10. With the pathway established by the router 22, users can use any one of the console devices to select and control any one of the computers 11. For example, User 1 can select and control computer 11A by using the first console device 15 via the KVM switch 20; User2 can select and control computer 11B by using the second console device 16 via the KVM switch 20 and the network; User3 can select and control computer 11C by using the third console device 17 via the KVM switch 20 and the network. In one embodiment, the router 22 can be a multiplexer, a matrix video switch or a cross point switch, a processor or the combination thereof.

Referring now to FIG. 1C, FIG. 1D and FIG. 1E, the pictorial diagram of the KVM broadcasting system according to the present invention, User1 may get the administration of the KVM system after a log-in step and become a broadcaster. The KVM switch 20 of the present invention provide a user interface such that a user with higher authority is able to perform broadcasting procedure as follows. After a user sends out a broadcast command to the KVM switch 20 from console device 15 by User 1, a pop-up window (FIG. 1E) shows up on the display of the console device 15. Thereafter, User1 assigns one computer 11A to be the broadcaster computer and choose a number of console devices other than the first console device 15 to be the broadcastee console devices. These assignment commands then are send to the KVM switch 20.

Referring next to FIGS. 1D & 1I, the firmware 21 in the KVM switch 20 changes the signal routing of the router 22 according the assignment commands from the first console device 15. For example, the console devices 15,16,17 operate the computers 11A,11B,11C respectively before the KVM switch 20 enters a broadcast session as shown in FIG. 1C and FIG. 1H. After receiving the broadcast assignment commands from the first console device 15, the firmware 21 makes the signal routing disconnected between console devices 16,17 and the computers 11B,11C, and then broadcasts the output signals of computer 11A to the console devices 16,17. At this movement, the keyboard 16b,17b and mice 16c,17c are disabled, or disconnected to the any one of the computers 11A, 11B, 11C and 11D by the KVM switch 20.

To terminate the broadcasting, User1 sends out a broadcast terminate command to the KVM switch 20. The firmware 21 on the KVM switch 20 disconnects the broadcast signals from computer 11A to console device 16,17, and then re-connects the original connections between the console device 16,17 and the computer 11B,11C respectively as shown in FIG. 1H.

In another preferred embodiment, referring now to FIGS. 1J & 1K, a KVM switch 20 couples a plurality of controlled computers 11 to a plurality of console devices located remotely. For example, the plurality of console devices located remotely include a first console device 15, a second console device 16 and a third console device 17. The KVM switch 20 includes a computer interface 24 and a network interface 25. The computer interface 24 connects the controlled computers 11A,11B,11C and 11D.

The computer interface 24 may further include video ports, keyboard ports, mouse ports, audio ports and USB ports. The network interface 25 connects the remote console devices associated with computers 15d,16d and 17d through network 10. The network interface 25 may include an RJ-45 connector. The operation steps is the same as the two preferred embodiment mentioned above.

While the invention has been described by way of examples and in terms of preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A Keyboard-Video-Mouse switch, coupling a plurality of console devices to a plurality of computers, the Keyboard-Video-Mouse switch comprising:
a control interface, for connecting the plurality of console devices;
a computer interface, for connecting the plurality of computers and receiving video signals from the plurality of computers;
a video matrix switch, routing the video signals between the computer interface and the control interface; and
a processor, in communication with the control interface and the video matrix switch, routing a first control signal from a first console device, selected form the plurality of console devices, to a first computer selected from the plurality of computers, and routing a second control signal from a second console device, selected form the plurality of console devices, to a second computer selected from the plurality of computers,
wherein the video matrix switch transmits a first video signal from the first computer to the first console device and at least the second console device under the control of the processor, in response to a first command from the first console device.

2. The Keyboard-Video-Mouse switch of claim 1, wherein the video matrix switch, in response to the first command, further interrupts a second video signal from the second computer to the second console device.

3. The Keyboard-Video-Mouse switch of claim 1, further comprises:
an interface for selecting the first computer from the plurality of computers, and selecting at least the second console device from the plurality of console devices.

4. The Keyboard-Video-Mouse switch according to claim 3, wherein the interface comprises an OSD menu displayed on a display of the first console device.

5. The Keyboard-Video-Mouse switch according to claim 1, wherein the processor, in response to the first command, disconnects a keyboard and a mouse of the second console device to any one of the plurality of computers.

6. The Keyboard-Video-Mouse switch according to claim 1, wherein a keyboard and a mouse of the second console device are disabled in response to the first command.

7. The Keyboard-Video-Mouse switch according to claim 1, wherein the processor, in response to the first command, blocks the second control signal from the second console device to any one of the plurality of computers.

8. The Keyboard-Video-Mouse switch according to claim 1, wherein the video matrix switch, in response to a second command received after the first command, reconnects the second console device to the second computer.

9. A Keyboard-Video-Mouse switch, coupling a plurality of console devices and to a plurality of computers, the Keyboard-Video-Mouse switch comprising:
a control interface, for connecting the plurality of console devices;
a computer interface, for connecting the plurality of computers and receiving video signals from the plurality of computers;
a video matrix switch, routing video signals between the computer interface and the control interface;
a plurality of multiplexers, each of which corresponding to each of the plurality of console devices, respectively;
an OSD generating circuit, in communication with the multiplexers and the video matrix switch, for generating an OSD menu on a display of a first console device, selected form the plurality of console devices, as an interface for a user to select at least a second console device from the plurality of console devices and a first computer from the plurality of the computers; and
a processor, in communication with the control interface and the video matrix switch, routing a first control signal from the first console device to the first computer, and routing a second control signal from the second console device to the second compute,
wherein the video matrix switch disconnects the second console device to the second computer, and transmits a first video signal from the first computer to the first console device and at least the second console device under the control of the processor, in response to a first command from the first console device,
wherein the multiplexers and the OSD generating circuit are controlled by the processor such that the OSD menu is combined with the first video signal form the first computer, or overlapped with the first video signal form the first computer,
wherein the video matrix switch, in response to a second command received after the first command, reconnects the second console device to the second computer.

10. The Keyboard-Video-Mouse switch of claim 9, wherein the video matrix switch, in response to the first command, further interrupts a second video signal from the second computer to the second console device.

11. The Keyboard-Video-Mouse switch according to claim 9, wherein the processor, in response to the first command, disconnects a keyboard and a mouse of the second console device to any one of the plurality of computers.

12. The Keyboard-Video-Mouse switch according to claim 9, wherein a keyboard and a mouse of the second console device are disabled in response to the first command.

13. The Keyboard-Video-Mouse switch according to claim 9, wherein the processor, in response to the first command, blocks the second control signal from the second console device to any one of the plurality of computers.

14. A Keyboard-Video-Mouse switch, coupling a plurality of console computers to a plurality of controlled computers, the Keyboard-Video-Mouse switch comprising:
a network interface, for connecting the plurality of console computers;
a computer interface, for connecting the plurality of controlled computers and receiving video signals from the plurality of controlled computers;
a video matrix switch, routing the video signals between the computer interface and the control interface; and
a processor, in communication with the network interface and the video matrix switch, routing a first control signal from a first console computer, selected form the plurality of console computers, to a first controlled computer selected from the plurality of controlled computers, and routing a second control signal from a second console computer, selected form the plurality of console computers, to a second controlled computer selected from the plurality of controlled computers,
wherein the video matrix switch transmits a first video signal from the first controlled computer to the first console computer and at least the second console computer under the control of the processor, in response to a command from the first console computer.

15. The Keyboard-Video-Mouse switch of claim 14, wherein the video matrix switch, in response to the command, further interrupts a second video signal from the second controlled computer to the second console computer.

16. The Keyboard-Video-Mouse switch of claim 14, further comprises:
an interface for selecting the first controlled computer from the plurality of controlled computers, and selecting the second console computer from the plurality of console computers.

17. The Keyboard-Video-Mouse switch according to claim 16, wherein the interface comprises an OSD menu displayed on a display of the first console computer.

18. The Keyboard-Video-Mouse switch according to claim 14, wherein the processor, in response to the command, disconnects a keyboard and a mouse of the second console computer to any one of the plurality of computers.

19. The Keyboard-Video-Mouse switch according to claim 14, wherein a keyboard and a mouse of the second console computer are disabled in response to the command.

20. The Keyboard-Video-Mouse switch according to claim 14, wherein the processor, in response to the command, blocks the second control signal from the second console computer to any one of the plurality of computers.
